(19) United States
(12) Patent Application Publication
(10) Pub. No.: US 2014/0304805 A1
(43) Pub. Date: Oct. 9, 2014

(54) INFORMATION PROCESSING APPARATUS AND IMAGE FORMING APPARATUS

(71) Applicant: Sharp Kabushiki Kaisha, Osaka (JP)

(72) Inventor: Hitoshi Mitsui, Osaka (JP)

(73) Assignee: Sharp Kabushiki Kaisha, Osaka (JP)

(21) Appl. No.: 14/200,827

(22) Filed: Mar. 7, 2014

(30) Foreign Application Priority Data
Apr. 4, 2013 (JP) 2013-078177

(51) Int. Cl. G06F 21/31

(52) U.S. Cl. CPC G06F 21/31
USPC 726/16

(57) ABSTRACT

It is enabled to execute a setting unique to a user easily without excessively increasing storage data capacity of a storage portion. A control portion, in the case of newly permitting login of a user, compares identification information included in authentication information of the user who is permitted to log in to identification information stored in the storage portion to determine whether the user who is newly permitted to log in is the same user as the user who logged in last time, and in the case where it is determined that the user who logged in last time and the user who has newly logged in are the same, reads operation information stored in the storage portion, to restore operations performed from login to logout last time.

### CROSS-NOTING PARAGRAPH

This non-provisional application claims priority under 35 U.S.C. §119(a) on Patent Application No. 2013-078177 filed in JAPAN on Apr. 4, 2013, the entire contents of which are hereby incorporated herein by reference.

### FIELD OF THE INVENTION

The present invention relates to an information processing apparatus and an image forming apparatus, and more specifically to an image forming apparatus capable of setting for each user by performing user authentication.

### BACKGROUND OF THE INVENTION

An information processing apparatus which performs authentication of a user, and when the authentication is performed successfully and login is permitted, executes processing corresponding to an operation of the user generally exists. This information processing apparatus has an operation input portion for receiving, for example, a user operation and a control portion for authenticating authentication information which is input to thereby permit login of a user and performing control for executing an action corresponding to operation input with respect to the above-described operation input portion. As one to which such an information processing apparatus is applied, there is an image forming apparatus provided with an image forming function, such as a printer with a single function or an MFP (Multifunction Peripheral) provided with a plurality of functions.

Some image forming apparatuses are able to register a setting value of a printing condition and the like used by users complicatedly. Further, there is also an image forming apparatus that, for enabling to register a setting value of each printing condition and the like for a plurality of users, authentication information such as an ID, a password and the like of a user is registered in the image forming apparatus in advance, and when the authentication information is input in login and authentication is performed successfully, a setting value which is set uniquely to the user is called to enable setting.

In this case, the user registers various setting values of the printing condition and the like in the image forming apparatus, and, for example, when authentication of the user is performed successfully for login, the registered setting values are displayed as a list so as to be selectable in the image forming apparatus. Then, by selecting the desired setting value from this list, the user is able to set the setting value easily to the image forming apparatus.

Here, the image forming apparatus allows a plurality of users to resister setting values thereof individually, and, by user authentication, is able to present a corresponding setting value for a specific user for selection. At this time, in a conventional image forming apparatus, a setting value of the printing condition and the like always becomes a predetermined initial value in login. Then, the user who logged in needs to select a setting value displayed as a list to thereby set the selected setting value to the image forming apparatus.

As to the image forming apparatus in which the registered setting value is called to be selected so that the setting value is able to be set in this manner, for example, Japanese Laid-Open Patent Publication No. 2008-009291 discloses an image forming apparatus that, in association with a user ID, a setting value for the user is registered, and in response to input of the user ID, the registered setting value is presented.

The image forming apparatus having the function as described above can take a form that, in an environment being set in, for example, a convenience store used by a lot of users, a user uses a wireless terminal apparatus such as a mobile phone or a smart phone and inputs authentication information registered in advance in the wireless terminal apparatus to the image forming apparatus by wireless communication to thereby perform login processing to the image forming apparatus.

In such a case, for example, when a microwave which emits electric waves of the same band as a frequency band (for example, 2.4 GHz) used for wireless communication between the wireless terminal apparatus and the image forming apparatus exists in the store and the microwave is used in login by the wireless terminal apparatus, wireless communication is disconnected and logout is performed forcibly in the image forming apparatus. In this case, the user needs to perform an operation for performing login to the image forming apparatus again. In this manner, there is a case where logout is performed forcibly without intention of the user because of disconnection of communication which is not intended by the user. Alternatively, there is also a case where the user takes time for the operation, followed by forced logout due to time out.

In this case, when the user performs the login operation again, it requires time and labor for calling and displaying the setting list to select the setting value for resetting, thus imposing excess burden on the user.

Moreover, in the case of one for registering a setting value in association with a user ID like the image forming apparatus described in Japanese Laid-Open Patent Publication No. 2008-009291, it is necessary to allocate storage capacity for storing a setting value even with respect to a user whose use frequency is less, so that in the case of the image forming apparatus used by a lot of users in a convenience store or the like, a huge amount of storage capacity is required, thus bringing more complication of the apparatus configuration and higher cost.

### SUMMARY OF THE INVENTION

The present invention aims to provide an information processing apparatus capable of executing a setting unique to a user easily without excessively increasing storage capacity of a storage portion, and an image forming apparatus provided with the information processing apparatus.

An object of the present invention is to provide an information processing apparatus having an operation input portion for receiving a user operation, and a control portion for performing control to permit login of a user by authenticating authentication information which is input and execute an action corresponding to operation input to the operation input portion, wherein a storage portion for storing identification information for identifying the user who logged in and operation information for the operation input portion from login to logout is included, and the control portion, in the case of newly permitting login of a user, compares identification information included in authentication information of the user who is permitted to log in to the identification information stored in the storage portion to determine whether the user who is newly permitted to log in is the same user as the user who logged in last time, and in the case where it is determined that the user who logged in last time and the user who has newly logged in are the same, reads the operation information stored in the storage portion to restore operations performed from login to logout last time.

Another object of the present invention is to provide the information processing apparatus, wherein the control portion, in the case where it is determined that the user who logged in last time and the user who has newly logged in are different users, sets an operation target to a predetermined initial state.

Another object of the present invention is to provide the information processing apparatus, wherein when logout is performed from a logged in state, the control portion updates the operation information stored in the storage portion to store the latest operation information from login to logout in the storage portion.

Another object of the present invention is to provide the information processing apparatus, wherein a storage area of the storage portion having the operation information stored therein is a nonvolatile memory area or a memory area which is backed up by a predetermined back up power source.

Another object of the present invention is to provide an image forming apparatus provided with the above information processing apparatus and an image forming portion for performing image formation of image data on a recording medium in accordance with operation input to the information processing apparatus.

### BRIEF DESCRIPTION OF THE DRAWINGS

FIG. 1 is a block diagram explaining a configuration of an embodiment of an image forming apparatus according to the present invention; and

FIG. 2 is a flowchart explaining an example of processing in the image forming apparatus according to the present invention.

### PREFERRED EMBODIMENTS OF THE INVENTION

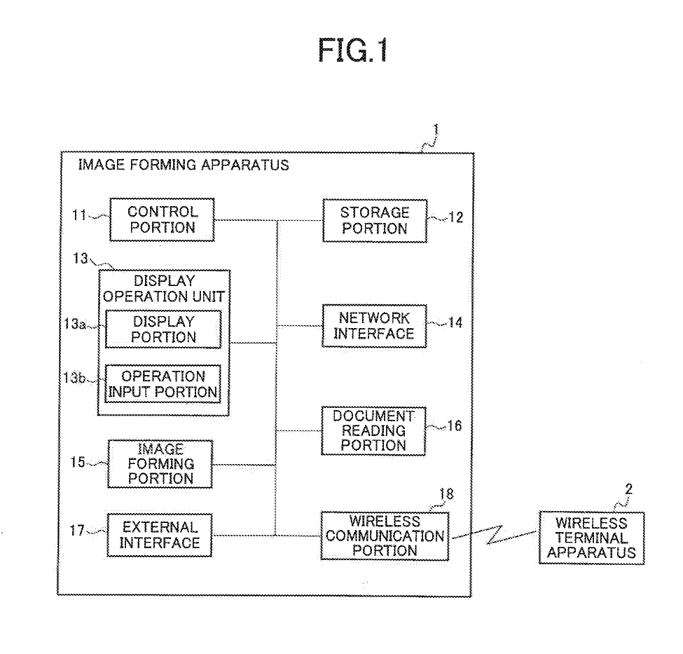

FIG. 1 is a block diagram, explaining a configuration example of an embodiment of the present invention, showing a configuration example of an image forming apparatus provided with an information processing apparatus according to the present invention.

A control portion 11 is configured by a CPU )Central Processing Unit), and controls each component of the image forming apparatus 1. The control portion 11 performs control to execute various actions of the image forming apparatus 1 by reading various control programs stored in a storage portion 12 for execution.

The storage portion 12 is storage means using a storage device such as a hard disk or a semiconductor memory such as a ROM (Read Only Memory) or a RAM (Random Access Memory). In a storage area of the storage portion 12, identification information for identifying a user who logged in to the image forming apparatus 1 last time and operation information performed for an operation input portion 13b from login to logout are stored.

A display operation unit 13 is configured by a display portion 13a for presenting various information and the operation input portion 13b for receiving operation input from the user. The operation input portion 13b receives operation input by a user operation to transmit to the control portion 11, and a device which receives operation input by a keyboard or a button and a device which receives operation input by a touch operation by the user are applicable. A touch device is able to constitute a touch panel by being integrally attached to the display portion 13a.

A network interface 14 provides connection to a network (typically, a LAN (Local Area Network) connected to the internet), and performs communication control for transmitting and receiving data to and from an external device such as a PC (Personal Computer) on the network.

An image forming portion 15 performs image formation (printing) of image data for printing transmitted from an external PC or the like or image data read by a document reading portion 16 on recording paper. The image forming portion 15 is provided with electrophotographic image forming portions such as, for example, a print engine, a photoreceptor drum, a charger for charging the photoreceptor drum at predetermined potential, a laser scanning device for forming an electrostatic latent image on a surface of the photoreceptor drum, a developing device for supplying a toner to the electrostatic latent image on the surface of the photoreceptor drum for visualizing and a transfer device for transferring a toner image on the surface of the photoreceptor drum onto a sheet. The image forming portion 15 may have any system of an ink jet system, a neat transfer system and the like, in addition to the electrophotographic system.

The document residing portion 16 is provided with a CCD (Charge Coupled Device) for residing a document image, and reads the document image to convert into electronic image data for outputting.

An external interface 17 constitutes an interface for connecting an external recording medium such as a USB (Universal Serial Bus) memory or an SD card.

A wireless communication portion 18 is an interface for performing wireless communication with a wireless terminal apparatus 2, for example, such as a smartphone or a mobile phone. The wireless communication portion 18 is able to transmit and receive data by wireless communication to and from the wireless terminal apparatus 2, to which communication systems including a wireless LAN such as WiFi (registered trademark) , Near Field Communication (NFC) such as infrared communication or Bluetooth (registered trademark), or the like may be applied.

With the above-described configuration, the control portion 11 realizes an authentication function for authenticating a user who performs login to the image forming apparatus 1. The login is an operation for identifying identity and validity of the user at the time of starting to user the image forming apparatus 1 to obtain license information which is necessary for access to various resources, and for performing login, generally, a user ID and a password that are identification information for identifying the user are input. The password is used as a means for authentication, and is able to be substituted by other authenticating methods. In the control portion 11, by collating the user ID and the password, which are input to the user ID and the password which are registered in advance to thereby judge whether or not to permit login.

Alter login is permitted to be in a logged in state, when the user performs a predetermined operation for finishing a session of the logged in state, logout is performed. Further, logout is also performed forcibly without intention of the user, for example, when communication with the wireless terminal apparatus 2 performing a login operation is interrupted or due to time out and the like.

In a case where the user logs in, the operation input portion 13b may be used to input a user ID and a password, or the wireless terminal apparatus 2 which stores a user ID and a password in advance may be connected to the image forming apparatus 1 so as to be communicable to transmit the user ID and the password from the wireless terminal apparatus 2 to the image forming apparatus 1 for login.

The control portion 11 temporarily stores operation information which is performed till when logout is performed after the user logs in normally in the storage portion 12. The operation information is information which enables to judge, operation contents and operation procedure when sin operation for changing setting of a printing condition, or the like from a predetermined initial state, and by using the operation information, it is possible to restore changed setting from the initial state.

For example, in a case where the user logs in to the image forming apparatus 1 to set a paper size for performing data scanning of image data which is saved or perform operation for setting a destination of scan notification, and then logs out, operation information in which the initial state is changed is stored in the storage portion 12 in association with a user ID thereof.

Then, when a next new login occurs, the control portion 11 judges whether the same user as the user who logged in last time performs login based on the user ID. Further, when the same user logs in, the previous operation information stored in the storage portion. 12 is used to restore the changed, operation from the initial state. Here, if the printing condition or the like is set by the previous operation, it is possible to restore the setting state and display an operation screen on the display portion 13a in the state at the time of logout. Thereby, even when the operation is temporarily interrupted due to forced logout or the like, if other user does not log in, a user is able to execute the subsequent operation in the restored state at the time of logout without necessity of repeating the operation again.

Further, when a next new login occurs, in the case of login by a user different from the last time, the previous operation information stored in the storage portion 12 is deleted from the storage portion 12. Then, the operation from the initial state is enabled. Thereby, in a case where other user logs in, it becomes possible to perform setting operation not from the state at the time of previous logout but the initial state.

To an area in which the operation information is stored among the storage area of the storage portion 12, a nonvolatile memory such as a flash memory is applicable. Alternatively, a storage area which is backed up by a predetermined back-up power source and backed up even when main power of the image forming apparatus 1 is turned off is possible. This makes it possible to keep past operation information available even when power of the image forming apparatus 1 is turned off.

The above-described, image forming apparatus 1 includes an embodiment of the information processing apparatus according to the present invention. The information processing apparatus has the operation input portion 13b for receiving a user operation and the control portion 11 for performing control to permit login of a user by authenticating authentication information which is input, and execute an action corresponding to operation input with respect to the operation input portion 13b, and further has the storage portion 12 for storing identification information for identifying a user who logged in last time and operation information for the operation input portion 13b from login to logout. The image forming apparatus 1 is configured as an image forming apparatus provided with such an information processing apparatus and the image forming portion 15 for performing image formation of image data on recording medium in accordance with operation input with respect to the information processing apparatus.

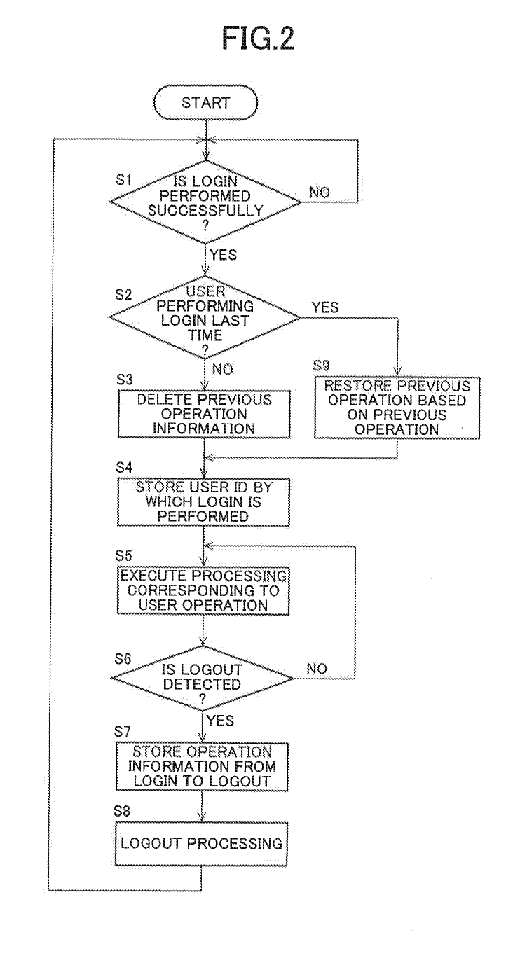

FIG. 2 is a flowchart explaining an example of processing in the information processing apparatus according to the present invention. Description will be given for procedure of the processing with reference to the configuration of the image forming apparatus of FIG. 1.

First, the control portion 11 judges that a user performs a login operation and login is performed normally (step S1). Whether or not login is performed successfully is judged by authenticating authentication information such as a user ID and a password input by the user using the operation input portion 13b. The above-described authentication information which is input by the user may be transmitted from the wireless terminal apparatus 2.

When login is not performed successfully, judgment is continued until login is performed successfully. Moreover, in a case where login is performed successfully, the control portion 11 determines whether or not the user who logged in last time successfully and the user newly performing login successfully this time are the same user based on the user ID of login which is performed, successfully (step S2). Here, in a case where a user different from the last time logs in, previous operation information stored in the storage portion 12 is deleted to return setting to the initial state (step S3), and the user ID by which login is performed this time is stored in the storage portion 12 (step S4).

Moreover, in a case where the user who logs in this time is the same as the user who logged in last time at step S2, the control portion 11 firstly reads previous operation information from the storage portion 12, and restores the previous operation from the initial state based on the operation information. For example, an operation of changing for an operation screen, setting a condition or the like is restored to set to the state at the time of previous logout. Then, the procedure moves to step S4 to store the user ID by which login is performed this time in the storage portion 12.

When the user ID is stored at step S4, the control portion 11 executes processing in accordance with the user operation for the operation input portion 13b (step S5). For example, in accordance with the user operation, control is performed to execute processing for switching a screen and actions concerning setting of various conditions.

At this time, in a case where login is performed by the user same as the user who logged in last time at step S2, the user is able to continue operation input with respect to the state at the time of previous logout that is restored at step S9. Further, in a case where login is performed by a user different from the user who logged in last time at step S2, the user is able to perform arbitrary operation input from the initial state.

Moreover, in this period, the control portion 11 detects whether or not logout is performed (step S6), and when logout is not performed, continues processing in accordance with the user operation. Further, in the case of detecting that logout is performed, operation information performed from login to logout is stored in the storage portion 12 (step S7). It is possible that, in the case of storing the operation information in the storage portion 12, operation information stored in the storage portion 12 is updated so that the latest operation information from login to logout is stored in the storage portion 12. Thereby, it is possible to store past operation information to be available without increasing capacity of data to be recorded in the storage portion 12.

Moreover, in the case of storing the operation information in the storage portion 12, a method for always performing back up of a part serving as a storage area for storing the operation information therein with a power source different from that of other parts or using a nonvolatile memory such as a flash memory to save storage information therein is applicable. In the nonvolatile memory, a storage area for one user is secured and updating is performed by overwriting sequentially, thus making it possible to reduce consumption of capacity.

Then, logout processing is executed (step S8). The logout processing here is for performing processing such as prohibiting operations other than the operation concerning login to further switch power at a portion where large amount of power is consumed to power saving, and in the case of switching to power saving, power of a normal action is restored when next login is detected.

As described above, the information processing apparatus of the present invention is an information processing apparatus having an operation input portion for receiving a user operation, and a control portion for performing control to permit login of a user by authenticating authentication information which is input and execute an action corresponding to operation input to the operation input portion, in which a storage portion for storing identification information for identifying the user performing login and operation information for the operation input portion from login to logout is included, and the control portion, in the case of newly permitting login of a user, compares identification information included in authentication information of the user who is permitted to log in to identification information stored in the storage portion to determine whether the user who is newly permitted to perform login is the same user as the user who logged in, and in the case where it is determined that the user who logged in last time and the user who has newly logged in are the same, reads operation information stored in the storage portion to restore an operation from login to logout last time. Thereby, it is possible to provide the information processing apparatus in which even when an operation is temporarily interrupted due to forced logout or the like, if other user does not log in, a user is able to execute the subsequent operation in the restored state at the time of logout without necessity of repeating the operation again, and execute setting unique to the user easily without excessively increasing storage capacity of the storage portion which stores a setting value.

Further, the information processing apparatus of the present invention is that the control portion, in the case where it is determined that the user who logged in last time and the user who has newly logged in are different users, sets an operation target to a predetermined initial state. Thereby, in a case where other user logs in, it becomes possible to perform the setting operation not from the state at the time of previous logout but the initial state.

Further, the information processing apparatus of the present invention is that, when logout is performed from a logged in state, the control portion updates the operation information stored in the storage portion to store the latest operation information from login to logout in the storage portion. Thereby, it is possible to store past operation information to be available without increasing capacity of data to be recorded in the storage portion.

Further, the information processing apparatus of the present invention is that a storage area of the storage portion having the operation information stored therein is a nonvolatile memory area or a memory area which is backed up by a predetermined back up power source. Thereby, it is possible to keep past operation information available even when power of an image forming apparatus is turned off.

The image forming apparatus of the present invention is sin image forming apparatus provided with the above-described information processing apparatus and an image forming portion for performing image formation of image data on recording medium in accordance with operation input with respect to the information processing apparatus. Thereby, it becomes possible to execute the setting unique to a user easily without excessively increasing storage capacity of the storage portion which stores a setting value.

Hereinabove, according to the present invention, it is possible to provide an information processing apparatus capable of executing the setting unique to a user easily without excessively increasing storage capacity of a storage portion, and an image forming apparatus provided with the information processing apparatus.

1. An information processing apparatus having an operation input portion for receiving a user operation, and a control portion for performing control to permit login of a user by authenticating authentication information which is input and execute an action corresponding to operation input to the operation input portion, wherein
a storage portion for storing identification information for identifying the user who logged in and operation information for the operation input portion, from login to logout is included, and
the control portion, in the case of newly permitting login of a user, compares identification information included in authentication information of the user who is permitted to log in to the identification information stored in the storage portion to determine whether the user who is newly permitted to log in is the same user as the user who logged in last time, and
in the case where it is determined that the user who logged in last time and the user who has newly logged in are the same, reads the operation information stored in the storage portion to restore operations performed from login to logout last time.

2. The information processing apparatus as defined in claim 1, wherein
the control portion, in the case where it is determined that the user who logged in last time and the user who has newly logged in are different users, sets an operation target to a predetermined initial state.

3. The information processing apparatus as defined in claim 1, wherein
when logout is performed from a logged in state, the control portion updates the operation information stored in the storage portion to store the latest operation information from login to logout in the storage portion.

4. The information processing apparatus as defined in claim 1, wherein
a storage area of the storage portion having the operation information stored therein is a nonvolatile memory area or a memory area which is backed up by a predetermined back up power source.

5. An image forming apparatus provided with the information processing apparatus as defined in claim 1 and an image forming portion for performing image formation of image data on a recording medium in accordance with operation input to the information processing apparatus.
